(19) United States
(12) Patent Application Publication
(10) Pub. No.: US 2006/0166827 A1
(43) Pub. Date: Jul. 27, 2006

(54) Herbicidal composition

(76) Inventor: Georg Rudiger Kotzian, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/523,869

(22) PCT Filed: Aug. 7, 2003
(86) PCT No.: PCT/EP03/08791

§ 371 Date: Feb. 7, 2005

(30) Foreign Application Priority Data
Aug. 8, 2002 (CH) 1380/02

(51) Int. Cl. A01N 43/40

(52) U.S. Cl. 504/130

(57) ABSTRACT

A herbicidal composition comprising as active ingredient a mixture of a) at least one compound selected from tritosulfuron, flufenacet and propoxycarbazone (sodium), and b) a synergistically effective amount of at least one compound selected from the compounds of the group amidosulfuron, bentazone, bifenox, diflufenican, dicamba, dimethenamid, flurtamone, glufosinate, fenoxaprop-P-ethyl, iodosulfuron-methyl (sodium), bromoxynil, ioxynil, beflubutamid, imazosulfuron, cinidon-ethyl, 2,4-D, MCPA, MCPP, picolinafen, pendimethanlin, pyraflufen, imazethapyr, imazapic, imazapyr, imazaquin, imazamox and imazamethabenz-methyl, with the proviso that the mixtures of tritosulfuron with beflubutamid, tritosulfuron with mesosulfuron, tritosulfuron with iodosulfuron-methyl (sodium), tritosulfuron with ioxynil, tritosulfuron with dicamba, tritosulfuron with cinidon-ethyl, tritosulfuron with 2,4-D, picolinafen with cinidon-ethyl, flufenacet with picolinafen, flufenacet with fenoxaprop-P-ethyl, flufenacet with iodosulfuron-methyl (sodium), flufenacet with beflubutamid, flufenacet with mesosulfuron, flufenacet with cinidon-ethyl, flufenacet with imazamox, flufenacet with bifenox, flufenacet with diflufenican, flufenacet with flurtamone, flufenacet with glufosinate, flufenacet with pendimethalin, flufenacet with ioxynil, propoxycarbazone (sodium) with amidosulfuron, propoxycarbazone (sodium) with diflufenican, propoxycarbazone (sodium) with fenoxaprop-P-ethyl, propoxycarbazone (sodium) with iodosulfuron-methyl (sodium), propoxycarbazone (sodium) with bromoxynil, propoxycarbazone (sodium) with ioxynil, propoxycarbazone (sodium) with mesosulfuron, propoxycarbazone (sodium) with bifenox, propoxycarbazone (sodium) with flurtamone, propoxycarbazone (sodium) with picolinafen and propoxycarbazone (sodium) with glufosinate are excluded.

The present invention relates to a novel herbicidal synergistic composition comprising a herbicidal active ingredient combination that is suitable for the selective control of weeds in crops of useful plants, for example in crops of cereals.

The invention relates also to a method of controlling weeds in crops of useful plants and to the use of the novel composition for that purpose.

The compounds amidosulfuron, bentazone, bifenox, diflufenican, dicamba, flufenacet, dimethenamid, flurtamone, glufosinate, fenoxaprop-P-ethyl, iodosulfuron-methyl (sodium), bromoxynil, ioxynil, beflubutamid, imazosulfuron, cinidon-ethyl, 2,4-D, MCPA, MCPP, picolinafen, pendimethalin, pyraflufen, imazethapyr, imazapic, imazapyr, imazaquin, imazamox and imazamethabenz-methyl exhibit herbicidal action, as is described, for example, in The Pesticide Manual, 12th Edition (BCPC), 2000. Propoxycarbazone (sodium) is known from BCPC lectures in Brighton in 1999. Tritosulfuron, registered as No.142469-14-5 in CAS (Chemical Abstracts), is known from EP-A-559 814 and WO 01/24633, in which the herbicidal action of the compound is described. The compound 2-[[[[(4,6-dimethoxy-2-pyrimidinyl)amino]carbonyl]amino]sulfonyl]-4-[[(methylsulfonyl)amino]methyl]benzoic acid is known under the name mesosulfuron; its herbicidal action is described in EP-A-559 814 and WO 01/24633.

Surprisingly, it has now been found that a combination of variable amounts of at least two active ingredients from the above list exhibits a synergistic action that is capable of controlling, both pre-emergence and post-emergence, the majority of weeds occurring especially in crops of useful plants, without appreciably damaging the useful plant.

There is therefore proposed in accordance with the present invention a novel synergistic composition for the selective control of weeds, which comprises as active ingredient a mixture of

a) at least one compound selected from tritosulfuron, flufenacet and propoxycarbazone (sodium), and

b) a synergistically effective amount of at least one compound selected from the compounds of the group amidosulfuron, bentazone, bifenox, diflufenican, dicamba, dimethenamid, flurtamone, glufosinate, fenoxaprop-P-ethyl, iodosulfuron-methyl (sodium), bromoxynil, ioxynil, beflubutamid, imazosulfuron, cinidon-ethyl, 2,4-D, MCPA, MCPP, picolinafen, pendimethalin, pyraflufen, imazethapyr, imazapic, imazapyr, imazaquin, imazamox and imazamethabenz-methyl, with the proviso that the mixtures of tritosulfuron with beflubutamid, tritosulfuron with mesosulfuron, tritosulfuron with iodosulfuron-methyl (sodium), tritosulfuron with ioxynil, tritosulfuron with dicamba, tritosulfuron with cinidon-ethyl, tritosulfuron with 2,4-D, picolinafen with cinidon-ethyl, flufenacet with picolinafen, flufenacet with fenoxaprop-P-ethyl, flufenacet with iodosulfuron-methyl (sodium), flufenacet with beflubutamid, flufenacet with mesosulfuron, flufenacet with cinidon-ethyl, flufenacet with imazamox, flufenacet with bifenox, flufenacet with diflufenican, flufenacet with flurtamone, flufenacet with glufosinate, flufenacet with pendimethalin, flufenacet with ioxynil, propoxycarbazone (sodium) with amidosulfuron, propoxycarbazone (sodium) with diflufenican, propoxycarbazone (sodium) with fenoxaprop-P-ethyl, propoxycarbazone (sodium) with iodosulfuron-methyl (sodium), propoxycarbazone (sodium) with bromoxynil, propoxycarbazone (sodium) with ioxynil, propoxycarbazone (sodium) with mesosulfuron, propoxycarbazone (sodium) with bifenox, propoxycarbazone (sodium) with flurtamone, propoxycarbazone (sodium) with picolinafen and propoxycarbazone (sodium) with glufosinate are excluded.

It is extremely surprising that combinations of the afore-mentioned active ingredients exceed the additive effect on the weeds to be controlled that is to be expected in principle and thus broaden the range of action of both active ingredients especially in two respects: firstly, the rates of application of the individual compounds are reduced while a good level of action is maintained and, secondly, the composition according to the invention achieves a high level of weed control also in those cases where the individual substances, in the low rates of application range, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Bromus, Apera, Alopecurus, Matricaria, Abutilon, Sida, Xanthium, Amaranthus, Chenopodium, Ipomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable especially for controlling weeds in crops of useful plants, such as cereals and maize, and very especially for controlling weeds in cereals. “Crops of useful plants” are to be understood to mean also those which have been made tolerant to herbicides or classes of herbicides as a result of conventional methods of breeding or genetic engineering methods.

The composition according to the invention comprises the mentioned active ingredients in any mixing ratio, but usually has an excess of one component over the other. Preferred mixing ratios of the active ingredients are from 100:1 to 1:100 and 50:1 to 1:50.

Very especially effective compositions have been found to be the combinations tritosulfuron with amidosulfuron, tritosulfuron with bentazone, tritosulfuron with bifenox, tritosulfuron with diflufenican, tritosulfuron with dimethenamid, tritosulfuron with fenoxaprop-P-ethyl, tritosulfuron with flurtamone, tritosulfuron with glufosinate, tritosulfuron with bromoxynil, tritosulfuron with imazqsulfuron, tritosulfuron with pyraflufen, tritosulfuron with MCPA, tritosulfuron with MCPP, tritosulfuron with picolinafen, tritosulfuron with pendimethalin, tritosulfuron with imazethapyr, tritosulfuron with imazapic, tritosulfuron with imazapyr, tritosulfuron with imazaquin, tritosulfuron with imazamox, tritosulfuron with imazamethabenz-methyl, flufenacet with amidosulfuron, flufenacet with bentazone, flufenacet with dicamba, flufenacet with dimethenamid, flufenacet with bromoxynil, flufenacet with imazosulfuron, flufenacet with pyraflufen, flufenacet with 2,4-D, flufenacet with MCPA, flufenacet with MCPP, flufenacet with imazethapyr, flufenacet with imazapic, flufenacet with imazapyr, flufenacet with imazaquin, flufenacet with imazamethabenz-methyl, propoxycarbazone (sodium) with bentazone, propoxycarbazone (sodium) with dicamba, propoxycarbazone (sodium) with dimethenamid, propoxycarbazone (sodium) with beflubutamid, propoxycarbazone (sodium) with imazosulfuron, propoxycarbazone (sodium) with pyraflufen, propoxycarbazone (sodium) with cinidon-ethyl, propoxycarbazone (sodium) with 2,4-D, propoxycarbazone (sodium) with MCPA, propoxycarbazone (sodium) with MCPP, propoxycarbazone (sodium) with pendimethalin, propoxycarbazone (sodium) with imazethapyr, propoxycarbazone (sodium) with imazapic, propoxycarbazone (sodium) with imazapyr, propoxycarbazone (sodium) with imazaquin, propoxycarbazone (sodium) with imazamox, and propoxycarbazone (sodium) with imazamethabenz-methyl.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 0.001 to 1.5 kg of active ingredient mixture per ha.

The mixtures according to the invention may be used in unmodified form, that is to say as obtained in the synthesis. Preferably, however, they are formulated in customary manner, together with the adjuvants conventionally used in formulation technology, such as solvents, solid carriers or surfactants, for example into emulsifiable concentrates, directly sprayable or dilutable solutions, wettable powders, soluble powders, dusts, granules or microcapsules, as is described in WO 97/34483, pages 9 to 13. As with the nature of the compositions, the methods of application, such as spraying, atomising, dusting, wetting, scattering or pouring, are chosen in accordance with the intended objectives and the prevailing circumstances. The formulations, i.e. the compositions, preparations or products comprising the mixtures according to the invention, and also, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6. Depending on the nature of the active ingredients to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable in the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture, from 1 to 99.9% by weight of a solid or liquid formulation adjuvant, and from 0 to 25% by weight, especially from 0.1 to 25% by weight, of a surfactant.

Whereas concentrates are usually preferred as commercial products, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions: (%=percent by weight)

| | |
|---|---|
| Emulsifiable concentrates: | |
| active ingredient mixture: | 1 to 90%, preferably from 5 to 20% |
| surface-active agent: | 1 to 30%, preferably from 10 to 20% |
| liquid carrier: | 5 to 94%, preferably from 70 to 85% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably from 10 to 50% |
| water: | 94 to 24%, preferably from 88 to 30% |
| surface-active agent: | 1 to 40%, preferably from 2 to 30% |
| Wettable powders: | |
| active ingredient mixture: | 0.5 to 90%, preferably from 1 to 80% |
| surface-active agent: | 0.5 to 20%, preferably from 1 to 15% |
| solid carrier: | 5 to 95%, preferably from 15 to 90% |
| Granules: | |
| active ingredient mixture: | 0.1 to 30%, preferably from 0.1 to 15% |
| solid carrier: | 99.5 to 70%, preferably from 97 to 85% |

The Examples that follow illustrate the invention further. They do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂ | 85% | 78% | 55% | 16% |
| hydrocarbon mixture | | | | |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂ | 75% | 60% | — | — |
| hydrocarbon mixture | | | | |

The solutions are suitable for application in the form of micro-drops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1-1 mm) | | | |

for example CaCO₃ or SiO₂

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% | 92% | 80% |
| (diameter 0.1-1 mm) | | | |

for example CaCO₃ or SiO₂

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension | a) | b) | c) | d) |
|---|---|---|---|---|
| concentrates | | | | |
| active ingredient mixture | 3% | 10% | 25% | 50% |
| ethylene glycol | 5% | 5% | 5% | 5% |
| nonylphenol polyglycol | — | 1% | 2% | — |
| ether (15 mol of | | | | |
| ethylene oxide) | | | | |
| sodium lignosulfonate | 3% | 3% | 4% | 5% |
| carboxymethylcellulose | 1% | 1% | 1% | 1% |
| 37% aqueous | 0.2% | 0.2% | 0.2% | 0.2% |
| formaldehyde solution | | | | |
| silicone oil emulsion | 0.8% | 0.8% | 0.8% | 0.8% |
| water | 87.0% | 79.0% | 62.0% | 38.0% |

The finely ground active ingredient is intimately mixed with the adjuvants, giving a suspension concentrate from which suspensions of any desired concentration can be obtained by dilution with water. It is often more practical to formulate the active ingredients of the mixtures according to the invention separately and then, shortly before application, to bring them together in the applicator in the desired mixing ratio in the form of a “tank mixture” in water.

### BIOLOGICAL EXAMPLES

### Example B1

### Pre-Emergence Test

The test plants are sown in pots under greenhouse conditions. A standard soil is used as cultivation substrate. At a pre-emergence stage, the herbicides, both on their own and in admixture, are applied to the surface of the soil. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

### Example B2

### Post-Emergence Test

The test plants are grown in pots under greenhouse conditions until a post-application stage. A standard soil is used as cultivation substrate. At a post-emergence stage, the herbicides, both on their own and in admixture, are applied to the test plants. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

What is claimed is:

1. A herbicidal synergistic composition comprising as active ingredient a mixture of
a) at least one compound selected from tritosulfuron, flufenacet and propoxycarbazone (sodium), and
b) a synergistically effective amount of at least one compound selected from the compounds of the group amidosulfuron, bentazone, bifenox, diflufenican, dicamba, dimethenamid, flurtamone, glufosinate, fenoxaprop-P-ethyl, iodosulfuron-methyl (sodium), bromoxynil, ioxynil, beflubutamid, imazosulfuron, cinidon-ethyl, 2,4-D, MCPA, MCPP, picolinafen, pendimethalin, pyraflufen, imazethapyr, imazapic, imazapyr, imazaquin, imazamox and imazamethabenz-methyl, with the proviso that the mixtures of tritosulfuron with beflubutamid, tritosulfuron with mesosulfuron, tritosulfuron with iodosulfuron-methyl (sodium), tritosulfuron with ioxynil, tritosulfuron with dicamba, tritosulfuron with cinidon-ethyl, tritosulfuron with 2,4-D, picolinafen with cinidon-ethyl, flufenacet with picolinafen, flufenacet with fenoxaprop-P-ethyl, flufenacet with iodosulfuron-methyl (sodium), flufenacet with beflubutamid, flufenacet with mesosulfuron, flufenacet with cinidon-ethyl, flufenacet with imazamox, flufenacet with bifenox, flufenacet with diflufenican, flufenacet with flurtamone, flufenacet with glufosinate, flufenacet with pendimethalin, flufenacet with ioxynil, propoxycarbazone (sodium) with amidosulfuron, propoxycarbazone (sodium) with diflufenican, propoxycarbazone (sodium) with fenoxaprop-P-ethyl, propoxycarbazone (sodium) with iodosulfuron-methyl (sodium), propoxycarbazone (sodium) with bromoxynil, propoxycarbazone (sodium) with ioxynil, propoxycarbazone (sodium) with mesosulfuron, propoxycarbazone (sodium) with bifenox, propoxycarbazone (sodium) with flurtamone, propoxycarbazone (sodium) with picolinafen and propoxycarbazone (sodium) with glufosinate are excluded.

2. A method of controlling undesired plant growth in a crop of useful plants, which comprises allowing a herbicidally effective amount of a composition according to claim 1 to act on the crop plant or the area of cultivation thereof.

3. A method according to claim 2, wherein the crop plant is a cereal.
